(19) United States
(12) Patent Application Publication
(10) Pub. No.: US 2002/0199208 A1
(43) Pub. Date: Dec. 26, 2002

(54) System and method for uploading information from portable media and delivering it to storage across the internet

(76) Inventors: Matthew S. Chang, San Diego, CA (US); Aditya Krishnan, San Diego, CA (US); Andrew M. Proehl, San Francisco, CA (US); David K.L. Yang, San Jose, CA (US); Frederick J. Zustak, Poway, CA (US); Peter Rae Shintani, San Diego, CA (US); Mark Kenneth Eyer, San Diego, CA (US); Nicholas Colsey, Del Mar, CA (US); Brant L. Candelore, Escondido, CA (US); Dayan Ivy Golden, San Diego, CA (US)

Correspondence Address: FROMMER LAWRENCE & HAUG, 745 FIFTH AVENUE- 10TH FL., NEW YORK, NY, 10151, US

(21) Appl. No.: 09/892,914

(22) Filed: Jun. 26, 2001

(51) Int. Cl. H04N 7/173

(52) U.S. Cl. 725/131; 725/133; 725/114

(57) ABSTRACT

A kiosk that can be placed at any convenient location for providing a user with the ability to upload information stored in portable compact memory storage media and to forward the information to a network destination thereby freeing the portable compact memory storage media for storing additional information.

### BACKGROUND OF THE INVENTION

The present invention relates to a system and method for providing a user with the ability to upload information stored in portable compact memory storage media and to forward the information to a network destination thereby freeing the portable compact memory storage media for storing additional information.

As a result of advances in storage media and data compression technologies, portable compact storage media, such as flash media, scan media, memory sticks (“MS”), and floppy disks, have been used to store large amounts of information in digital form. Recent years have also seen the development of diverse portable digital devices, such as digital camcorders and digital still-picture cameras, for performing different functions utilizing such portable compact storage media for recording information. These devices may also include internal memories.

With the improvement of the performance and capabilities of such portable digital devices, their storage capacity requirements have also increased. For example, digital still-picture cameras have been continuously improving in resolution and image quality, and such improvements require more memory. Although portable compact storage media have become widely available, many types remain relatively expensive. Furthermore, portable compact storage media and digital devices can easily be misplaced, lost, or damaged, thus causing important information to be lost.

It may be practical in a mobile environment to upload the contents of a portable compact storage medium to a portable personal computer (“PC”), e.g., laptop, with a hard disk or other storage with a large capacity. However, laptops are expensive, relatively cumbersome, and equally susceptible to being damaged or lost. Such laptops might themselves crash. Hard disks used for storage in such laptops can be unreliable. Additionally, the transfer rate of a serial connection to the laptop may be slow, and faster interfaces are often expensive and may require resources that may not always be available.

In view of the foregoing, there is a need for an arrangement in which information stored in a portable compact storage medium can be conveniently and safely uploaded from a remote location and reliably saved to a home data storage so that the portable compact storage medium can be reused to store other information and the uploaded information may be processed.

### OBJECT OF THE INVENTION

Therefore, it is an object of the present invention to provide for the uploading of data stored in a portable compact storage medium from a remote location to a data storage.

Other objects and advantages of the invention will in part be obvious and will in part be apparent from the specification and the drawings.

### SUMMARY OF THE INVENTION

The present invention is directed to a system and method that includes kiosks located at various convenient locations that provide for the uploading of data from portable compact storage devices such as: flash media, scan media, MSs, floppy disks, and internal memories from portable devices such as digital cameras, and saving the uploaded data in a longer-term storage.

According to one aspect of the invention, data from a specific region of a portable compact storage device provides an email address or Universal Resource Locator (“URL”) path (or any access criteria) for routing the data to the longer-term storage through the Internet. The portable compact storage device may then be erased and re-used for other purposes.

The invention accordingly comprises the several steps and the relation of one or more of such steps with respect to each of the others, and the apparatus embodying features of construction, combination(s) of elements and arrangement of parts that are adapted to effect such steps, all as exemplified in the following detailed disclosure, and the scope of the invention will be indicated in the claims.

### BRIEF DESCRIPTION OF THE DRAWINGS

For a more complete understanding of the invention, reference is made to the following description and accompanying drawing(s), in which:

FIG. 1 illustrates an overall system configuration in accordance with an embodiment of the present invention;

FIG. 2 illustrates an internal structure of a kiosk shown in FIG. 1;

FIGS. 3A and 3B illustrate a flow chart for explaining a process of uploading and saving data stored in a portable compact storage device in accordance with an embodiment of the invention;

FIG. 4 illustrates a data structure of a portable compact storage device in accordance with an embodiment of the invention; and

FIGS. 5A and 5B illustrate a flow chart for explaining a process of uploading and saving selected data stored in a portable compact storage device in accordance with an embodiment of the invention.

### DETAILED DESCRIPTION OF PREFERRED EMBODIMENTS

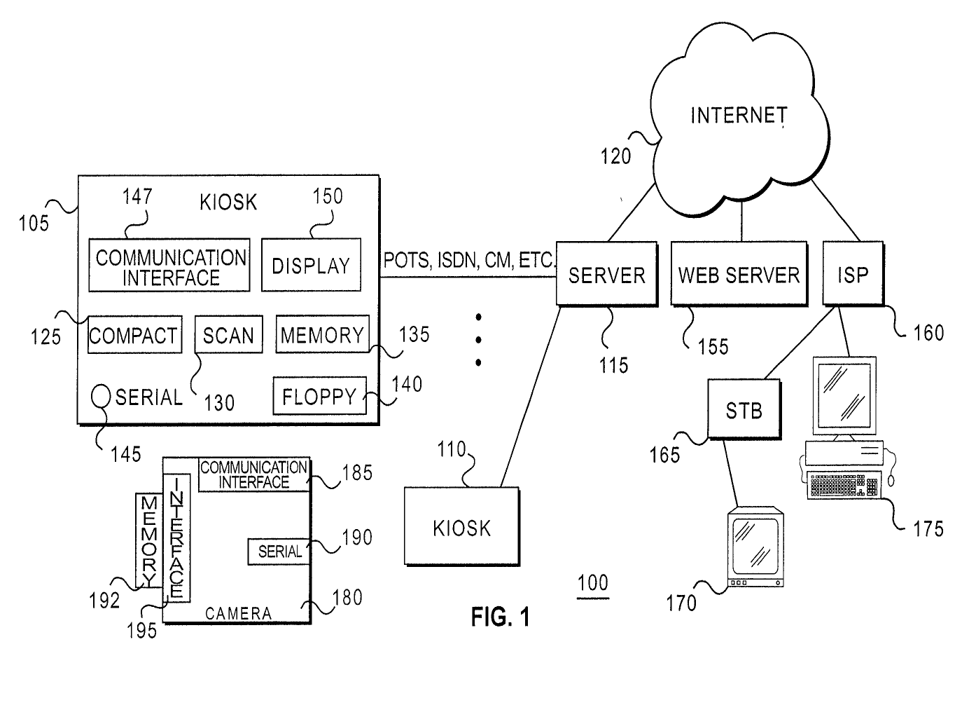

FIG. 1 shows an overall configuration of a system 100 according to an embodiment of the invention. As shown in FIG. 1, kiosks 105 and 110 are coupled through a server 115 to the Internet 120. Internet 120 is a packet switched network for transporting information and packets in accordance with the standard transmission control protocol/Internet protocol (“TCP/IP”). Kiosks 105 and 110 may access Internet 120 through, say, a plain old telephone service (“POTS”) connection using a conventional modem, an integrated services digital network (“ISDN”), a cable connection using a Data Over Cable System Interface Specification (“DOCSIS”) cable modem (“CM”), a digital subscriber line (“DSL”), a T1 line, and the like, to server 115.

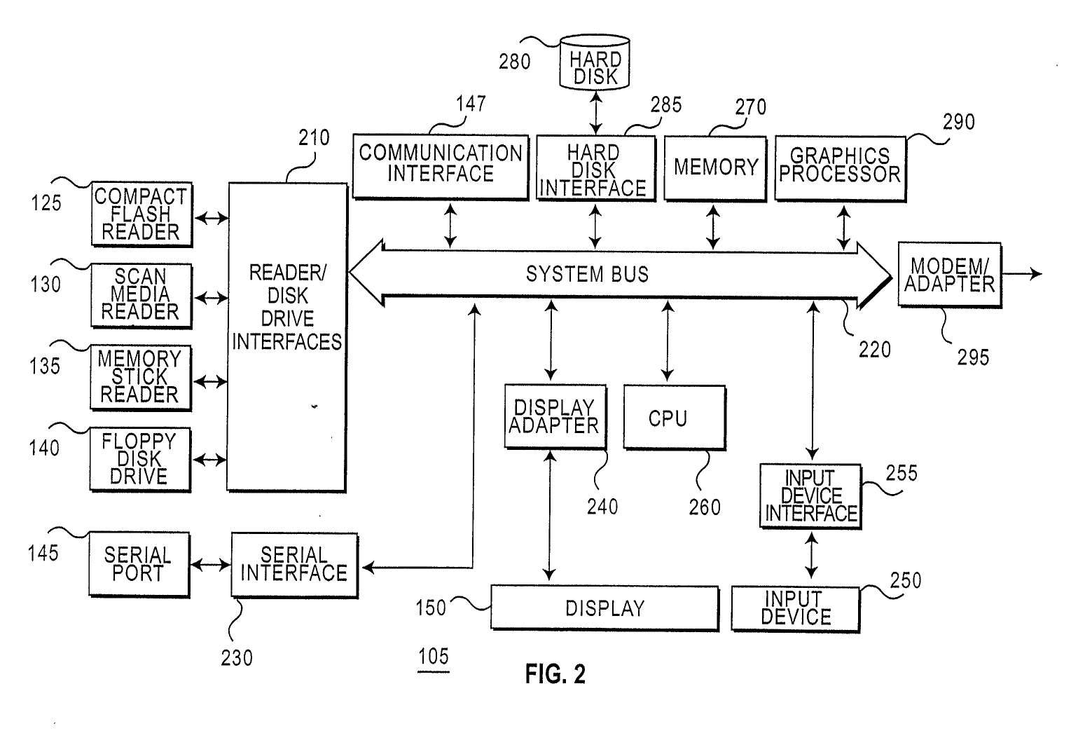

It is noted that kiosks 105 and 110 are included for illustrative purposes and that additional kiosks may also be connected to server 115. It is further noted that kiosks 105 and 110 may include similar components, and that the following description regarding either may be applied to the other. As shown in FIG. 1, kiosk 105 comprises a compact flash reader 125, a scan media reader 130, a memory stick (“MS”) reader 135, and a floppy disk drive 140 for receiving the respective types of portable compact storage media and for uploading data stored therein. Additional slots may also be included for receiving other types of portable compact storage media and for uploading data therefrom. Kiosk 105 further includes a serial RS-232 port 145 to enable wired interconnection to any suitable device, such as a portable digital still-picture camera, camcorder, personal digital assistant (PDA), and the like, for uploading data stored in the internal memories and/or detachable memories thereof. Wired communication with such devices may also be provided, for example, via an Ethernet port (not shown), a Universal Serial Bus (“USB”) port (not shown), an Institute of Electrical and Electronics Engineers (“IEEE”) 1394 (so-called “firewire” or “i-link”) or IEEE 1394 wide port (not shown), and a video input or S-video port (not shown). Kiosk 105 may include any other types of wired communication ports adapted to communicate with such devices. Kiosk 105 may also include a communication interface 147 adapted to receive and/or transmit signals from/to any such devices for wireless uploading of data stored in the internal memories and/or detachable memories thereof. Communication interface 147 may be, for example, an infrared port for receiving infrared signals of, say, the Infrared Data Association “IrDA” standard. Communication interface 147 may also be a receiver and/or transmitter of radio frequency (“RF”), microwave, and/or other wireless signals conforming to standards such as OpenAir™, IEEE 802.11, Bluetooth™, HIPERLAN, Home Radio Frequency (“HomeRF”), etc., from/to such devices. It is, thus, noted that kiosk 105 is not limited to the types of communications listed above but may include any receiver, wired or wireless, for communicating with any device for uploading data therefrom. A display 150 is also included on kiosk 105 for displaying messages to a user. Display 150 may be any cathode ray tube (“CRT”) display, liquid crystal display (“LCD”), or the like, and may include a touch screen for providing an interface to a user. A control panel, keyboard, keypad, or any other type of interface, such as input device 250 (FIG. 2), may also be provided.

Thus, as illustrated in FIG. 1, a camera 180 may be connected to kiosk 105 via a serial connection (e.g., cable) between serial interface 190 on camera 180 and serial port 145. Camera 180 may also communicate via communication interface 185 with kiosk 105 at communication interface 147 in accordance with one or more of the communication standards described above. Furthermore, camera 180 may include a memory 192, such as a so-called memory stick, that is detachable from a memory interface 195. Images and/or other data stored on memory 192 using camera 180 (or another device) may be downloaded by inserting memory 192 into memory reader 135 of kiosk 105. It is noted that camera 180 is described for illustrative purposes and that the present invention is not limited thereto. For example, PDAs, camcorders, digital music players, or the like, may be used to communicate with kiosk 105, and camera 180 or any such device may include one or more alternative types of memory storage (not shown) and/or communication interfaces (not shown).

As will be described in further detail below, data uploaded at kiosk 105 using readers/disk drive 125, 130, 135, 140, serial port 145, or communication interface 147 may be attached to an email and sent to an email address, or saved to a web site at a URL address. The destination email account or web site may be maintained at a web server 155 or Internet Service Provider (“ISP”) 160 connected to Internet 120. The web site may also be maintained at server 115 or even kiosk 105, which may include its own URL to provide for addressability by users via Internet 120. A user may then access the uploaded data using a set-top box (“STB”) 165 and television (“TV”) 170, or a computer 175 through a POTS, ISDN, CM, DSL, T1 line connection, etc., to ISP 160 and Internet 120. A server application at server 115, web server 155, or kiosk 105 may process the uploaded data and bill the customer appropriately. For example, a customer may be queried for a User Name and Password, and a credit card number (already input and stored) may be associated with that customer. Alternatively, the customer may be queried for payment information directly. The method of uploading data from kiosk 105 according to the present invention will be described in further detail below.

Kiosks 105 and 110 may be placed at strategic locations at tourist destinations, such as amusement parks, shopping centers, zoos, hotels, and the like. Server 115 and/or kiosks 105 and 110 may incorporate additional services and content for such a tourist destination along with the data uploading service. In accordance with an embodiment of the invention, kiosks 105 and 110 may be connected to server 115 through fiber-optic cables, coaxial cables, twisted pairs, an RF system, a microwave system, other wireless systems, a combination of wired and wireless systems, or any of a variety of electronic transmission media to form a LAN for such a tourist destination.

Referring now to FIG. 2, a system configuration for kiosk 105 in accordance with an embodiment of the invention is illustrated. As shown in FIG. 2, compact flash reader 125, scan media reader 130, memory stick reader 135, and floppy disk drive 140 are coupled to respective interfaces represented by reader/disk drive interfaces 210 for connecting to a system bus 220. Serial port 145 is connected to system bus 220 though a serial interface 230, and display 150 is connected to system bus 220 through a display adapter 240. Communication interface 147 may be connected directly to system bus 220, or may be connected through a suitable interface (not shown). As noted before, kiosk 105 may include a touch screen, control panel, keyboard, keypad, or any other type of interface, which is represented by input device 250 connected to system bus 220 through input device interface 255.

Kiosk 105 may further include a central processing unit (“CPU”) 260 and a memory 270, which may include Random Access Memory (“RAM”), Read Only Memory (“ROM”), and flash memory. Memory 270 and a hard disk 280 are suitable for storing data as well as instructions for programmed processes for execution on CPU 260. Hard disk 280 may be connected to system bus 220 through a hard disk interface 285. CPU 260 can thus access the data uploaded from readers/disk drive 125, 130, 135, and 140, serial port 145, and communication interface 147 via system bus 220. Uploaded video data may be passed to a graphics processor 290, which is optimized to process graphics information rapidly. For example, uploaded video data may be transcoded (converted directly from MPEG2 to a different, more compressed format, such as MPEG4 without decoding) before being stored and/or transmitted. Graphics processor 290 is also coupled to system bus 220 and operates under the control of CPU 260. It is noted that the function of graphics processor 290 may be handled by CPU 260.

Uploaded data may be transmitted to a user-designated destination (email address or URL address) using a modem/adapter 295, which may be coupled to system bus 220 for providing a connection to server 115 as shown in FIG. 1. Modem/adapter 295 may, for example, be a CM, DSL modem, ISDN terminal adapter, etc.

Kiosk 105 may also incorporate a smart card reader (not shown) for communicating with a so-called “smart card”, often serving as a Conditional Access Module (“CAM”). The CAM typically includes an independent CPU along with associated RAM and ROM memory. The smart card reader may be used to couple system bus 220 to a smart card serving as a CAM (not shown). Such smart card-based CAMs may be utilized for authentication of a user and authentication of transactions carried out by the user, as well as authorization of services and storage of authorized cryptography keys. For example, the CAM may be used to provide the key for encrypting the uploaded data for transmission, and decrypting the data at the user-designated destination that the CAM determines the user is authorized to receive.

It is noted that cryptographic functions may be performed by CPU 260 in accordance with algorithms stored in hard disk 280 and/or memory 270 to protect uploaded data from unauthorized access. Thus, as noted before, a customer may be queried for a User Name and Password, and/or a credit card number (which may be already input and stored) for completion of a transaction, whereupon data is encrypted and transmitted. The same information may be queried at the destination for decrypting the data.

During the operation of kiosk 105, an appropriate operating system may be loaded into, or may be permanently stored in, memory 270 or hard disk 280 along with the appropriate drivers for communication with the various interfaces. Along with the operating system and associated drivers, kiosk 105 may operate browser software for viewing, on display 150, web pages on Internet 120 (say, a web site maintained on web server 155 for storing uploaded data), or a web site maintained at server 115 for storing uploaded data for later access. Browser software may also provide the mechanism for viewing uploaded data, sending email messages with uploaded data attached thereto, etc.

While the above exemplary system 100, including kiosk 105, is illustrative of the basic components of a kiosk suitable for use with the present invention, the architecture shown should not be considered limiting since many variations of the hardware configuration are possible without departing from the present invention.

As described above, system 100 provides for uploading information stored in portable compact memory storage media and forwarding the information to a network destination thereby freeing the portable compact memory storage media for storing additional information. Exemplary processes for carrying out the invention will now be described in detail.

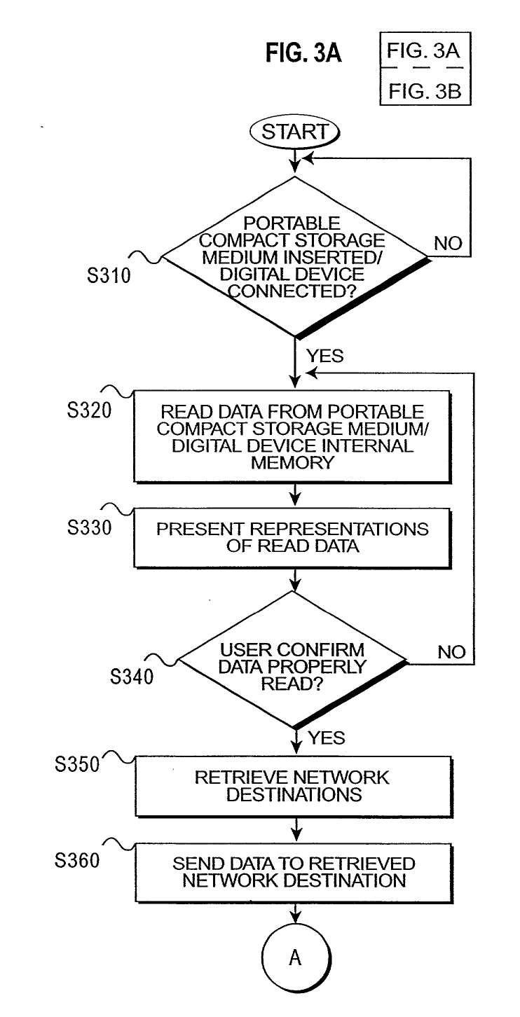

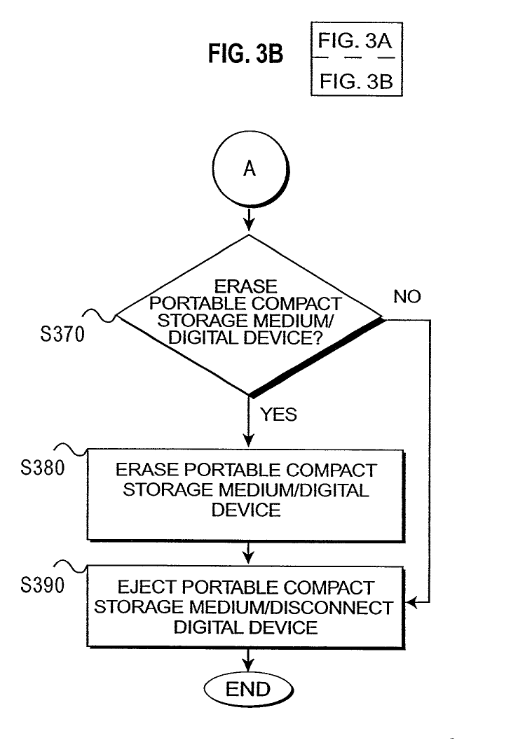

FIGS. 3A and 3B illustrate a process for uploading data stored in a portable compact memory storage medium or an internal memory of a portable digital device (hereinafter “storage medium/internal memory”) at kiosk 105 and sending said data to a network destination in accordance with an embodiment of the present invention.

As shown in FIGS. 3A and 3B, at step S310, kiosk 105 detects whether a portable compact memory storage medium is inserted into any of readers/disk drive 125, 130, 135, and 140, whether a portable digital device is connected to serial port 145, and whether an acknowledgement signal is received from a portable digital device at communication interface 147 indicating a connection thereto. If none are detected (“NO”), then step S310 is repeated. If a portable compact memory storage medium or a portable digital device is detected (“YES”), then control passes to step S320 where kiosk 105 reads the data from the inserted portable compact memory storage medium or the internal memory of the connected digital device. Preferably, kiosk 105 (CPU 260) may auto-detect which reader/disk drive 125, 130, 135, and 140, serial port 145, and communication interface 147 is being used, the amount of memory, and interface protocol required (if the interface allows for more than one protocol).

The data, which may include still-picture images, audio/video (“A/V”) clips, etc., may be stored in memory 270 and/or hard disk 280 of kiosk 105. The data may also include identification information such as an email address (to which the data is to be sent), manufacturer identification, application identification, application version number, etc. The data structure of a storage medium/internal memory according to an embodiment of the invention will be described in further detail below.

Referring back to FIGS. 3A and 3B, after kiosk 105 finishes reading data from the storage medium/internal memory, control passes to step S330 where a representation of the data is presented to the user on, say, display 150. For example, thumbnails of still-pictures or an index of scenes from a video clip may be displayed. Next, at step S340, it is determined whether the user confirms that the data has been properly uploaded. In other words, the user may view the data representation on display 150 and input a confirmation at input device 250 if the data is properly uploaded to kiosk 105. In accordance with an embodiment of the invention, kiosk 105 may independently confirm that the data transfer has been completed properly.

If the data has not been uploaded completely and properly, i.e. if user enters an indication of such (“NO”), then control is returned to step S320 where data from the storage medium/internal memory is read again. If the user enters a confirmation (“YES”), then control is passed to step S350 where a network destination is retrieved. As described before, the network destination may be an email address, URL address, or the like, entered by the user or read from the storage medium/internal memory (which may also be read at step S320). The user may also be prompted for a credit card number along with the network destination for charging a fee for the service. In accordance with an embodiment of the invention, the user may be prompted for a username and password whereupon kiosk 105 (CPU 260) may retrieve a pre-stored network destination(s) (an account at a URL address or “Picture Kiosk” web site) from hard disk 280, memory 270, server 115, and/or Internet 120. As described before, a server application at server 115, web server 155, or kiosk 105 may process the uploaded data and bill the customer appropriately, for example to a credit card number. According to another embodiment of the invention, the user may be prompted for a username and password before the storage medium/internal memory is received at step S310. Kiosk 105 may also attach ads and commercials to the uploaded data, and thus provide a “free” service.

After the network destination has been retrieved, control is passed to step S360 where the uploaded data is sent to the network destination. As noted before, the data may be attached to an email message sent to the user's email address, saved to the user's account at a URL address (web site), etc. According to an embodiment of the invention, data such as still-pictures may be processed, printed, and delivered to a physical address (through the mail system). If the data exceeds a data size limit for an email message, it may be segmented and attached to multiple email messages. In accordance with an embodiment, the data may be encrypted using a common algorithm, e.g., Advanced Encryption Standard (“AES”), and the user may be asked to input a Personal Identification Number (“PIN”) (or an encryption key representation). This PIN number or key may be also queried at the receiving end to decrypt the data.

Next, at step S370, the user may be queried as to whether the storage medium/internal memory is to be erased. If the user wishes to erase the storage medium/internal memory (“YES”), control is passed to step S380 where the storage medium/internal memory is erased. After the storage medium/internal memory has been erased at step S380 or if the user does not wish to erase the storage medium/internal memory at step S370 (“NO”), then control is passed to step S390 where the portable compact storage medium is ejected or the digital device may be disconnected, and the process is ended.

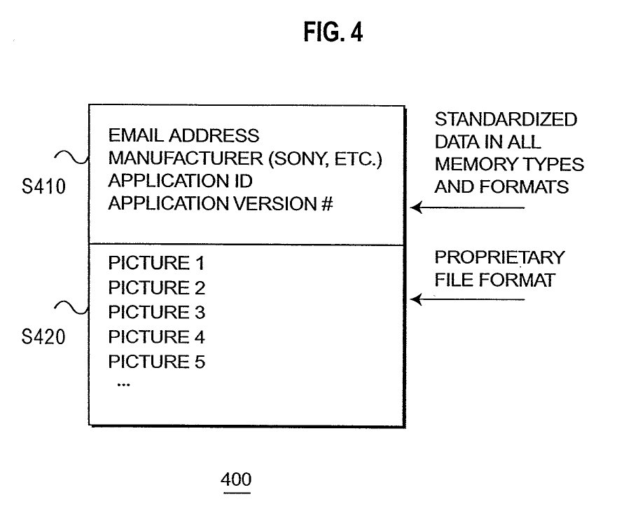

As described before, the network destination to which data is to be sent may be read from the storage medium/internal memory. FIG. 4 illustrates a data structure of a storage medium/internal memory that includes such a network destination (standardized routing information) in accordance with an embodiment of the invention. As shown in FIG. 4, data may be stored in a storage medium/internal memory in a memory file 400 that includes a standardized header 410 and data section 420. Header 410 may include an email address (or URL address), manufacturer, application ID, and application version number.

The files and the file structure on the storage medium/internal memory may be in a proprietary format particular to a manufacturer. Thus, kiosk 105 may auto-detect from header 410, the destination of where it is being sent, and the type of files (Manufacture & Version #) being uploaded. If the storage medium/internal memory does not include header 410, the customer may be queried for the manufacturer of the storage medium/internal memory, application ID, and/or application version number, along with the network destination at, say, step S350 described above. The manufacturer and file format information (and any encoding schemes) may also be used to process the data for alternative services, such as printing still-pictures, posters, emailing the data to a user designated mailing list or posting it on a web site in various formats.

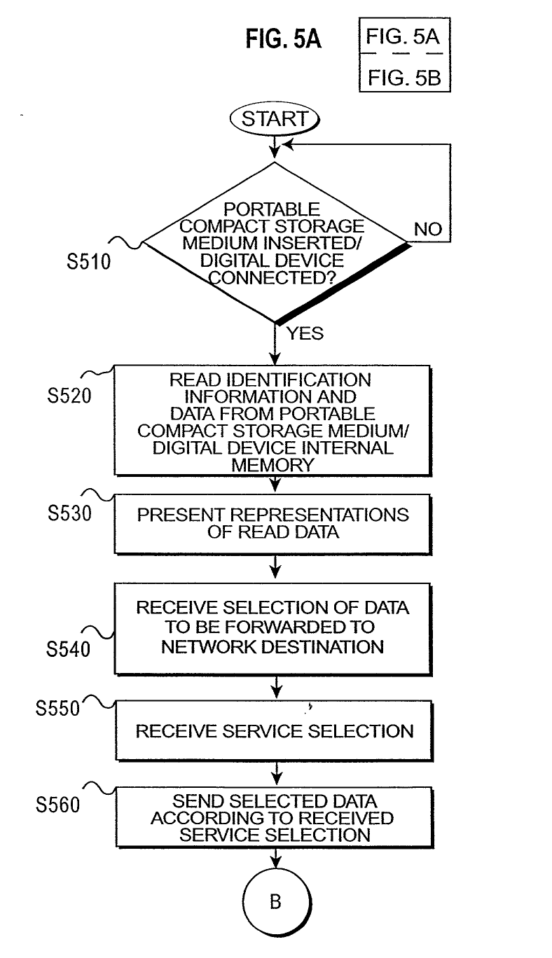

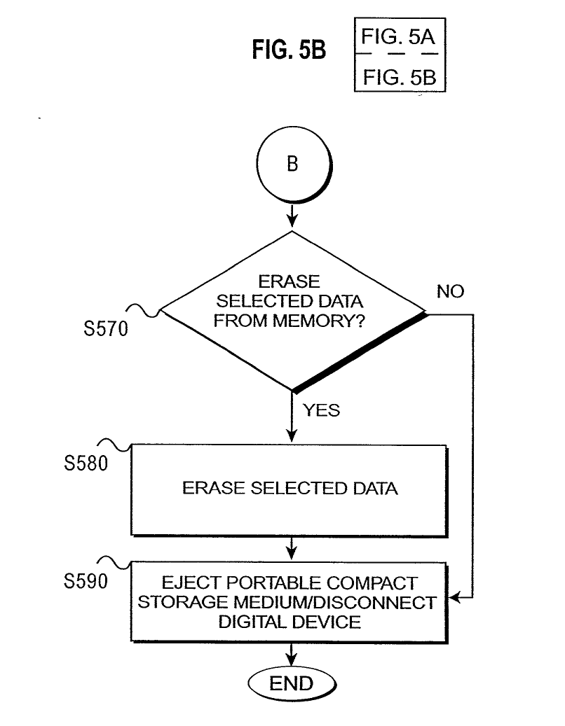

Referring now to FIGS. 5A and 5B, a process for uploading data stored in a storage medium/internal memory at kiosk 105 and sending selected data to a network destination in accordance with an embodiment of the present invention is illustrated.

As shown in FIGS. 5A and 5B, at step S510, kiosk 105 detects whether a portable compact memory storage medium is inserted into any of readers/disk drive 125, 130, 135, and 140 and whether a portable digital device is connected to serial port 145. If none are detected (“NO”), then step S510 is repeated. If a portable compact memory storage medium or a portable digital device is detected (“YES”), then control passes to step S520 where kiosk 105 reads the data from the connected storage medium/internal memory, including the identification information in header 410 (network destination, manufacturer, application ID, and application version number) and the actual data in data section 420. The data may be stored in memory 270 and/or hard disk 280 of kiosk 105.

After kiosk 105 finishes reading data from the storage medium/internal memory, control passes to step S530 where a representation of the data is presented to the user on, say, display 150, for the user to select the data to be sent. For example, thumbnails of still-pictures or an index of scenes from a video clip may be displayed for the user to select individual pictures or scenes to be sent. Next, at step S540, the user's selection is received. In other words, the user may view the data representation on display 150 and input a selection of the data that he/she would like to be sent to the network destination at input device 250. Control is then passed to step S550 where a selection of services is displayed on display 150 and a user's selection of service is received. For example, the user may select emailing to a pre-stored or entered list of email address(es), posting on a web site, processing and sending to a physical address, etc. The user may also be prompted for a credit card number for charging a fee for the selected service. In accordance with an embodiment of the invention, a profile of the user may be retrieved (from hard disk 280, memory 270, server 115, or Internet 120) according to the identification information from header 410 in the storage medium/internal memory. The user profile may include pre-stored user selections, services available to the user, credit card information, etc. (i.e., account information for the user at the URL address or “Picture Kiosk” web site maintained at, say, server 115).

After the user makes a service selection, control is passed to step S560 where the uploaded data is sent according to the user's selection. As noted before, the data may be attached to an email message sent to the user's email address, saved to the user's account at a URL address (web site), etc. If the data exceeds a data size limit for an email message, it may be segmented and attached to multiple email messages. As also described above, the data may be encrypted using a common algorithm, e.g., DES, and the identification information in header 410 of storage medium/internal memory may include an encryption key for the encryption.

Next, at step S570, the user may be queried as to whether the selected data in storage medium/internal memory is to be erased. If the user wishes to erase the selected data from storage medium/internal memory (“YES”), control is passed to step S580 where the selected data is erased from the storage medium/internal memory. After the selected data has been erased at step S580 or if the user does not wish to erase the selected data at step S570 (“NO”), then control is passed to step S590 where the portable compact storage medium is ejected or the digital device may be disconnected, and the process is ended.

In accordance with an embodiment of the invention, the services provided by kiosk 105 described thus far may be included in a software program that may be stored in the portable digital devices, e.g., cameras, PDAs, etc., and kiosk 105 may simply provide a network connection to server 115. The digital devices may also have direct access to the network (i.e., server 115) through a wireless connection without the need to connect to kiosk 105.

Furthermore, the data may be directly stored off site at a remote storage device, such as a storage account assigned to the user and provided at, say, web server 155 (e.g., Xdrive), via a connection to Internet 120 provided to the digital device by kiosk 105 and/or server 115.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense.

It is also to be understood that the following claims are intended to cover all of the generic and specific features of the invention herein described and all statements of the scope of the invention which, as a matter of language, might be said to fall therein.

What is claimed is:

1. A picture kiosk apparatus for receiving and outputting information, said apparatus comprising:
means for receiving a number of types of portable memory devices usable with and detachable from at least one of a video camera and a still-picture camera;
means for obtaining stored information from a received portable memory device;
means for determining at least one destination; and
means for outputting a data signal representative of at least a portion of the obtained information.

2. A picture kiosk apparatus according to claim 1, wherein the types of portable memory devices include at least one of a memory stick, a floppy disk, a scan medium, a hard disk, and a compact flash.

3. A picture kiosk apparatus according to claim 2, wherein the information stored in the respective memory device includes video information corresponding to a number of pictures.

4. A picture kiosk apparatus according to claim 2, wherein the information stored in the respective memory device includes video information corresponding to a number of moving image video clips.

5. A picture kiosk apparatus according to claim 2, wherein the information stored in the respective memory device includes identification information.

6. A picture kiosk apparatus according to claim 1, further comprising means for determining the type of the received portable memory device.

7. A picture kiosk apparatus according to claim 1, wherein
the obtained information includes destination information, and
the determining means determines the at least one destination based on the destination information.

8. A picture kiosk apparatus according to claim 1, further comprising means for receiving a destination designation, and wherein the determining means determines the at least one destination based on the received destination designation.

9. A picture kiosk apparatus according to claim 1, wherein the at least one destination includes at least one of an email address and a URL path.

10. A picture kiosk apparatus according to claim 1, further comprising means for erasing at least the portion of the obtained information from the received portable memory device.

11. A picture kiosk apparatus according to claim 1, further comprising:
means for presenting the obtained information; and
means for receiving a selection on the presented information, wherein
the portion of the obtained information includes the selected information.

12. A picture kiosk apparatus according to claim 1, wherein the outputting means is adapted to be coupled to a computer network for outputting the data signal representative of the at least a portion of the obtained information for supply by way of the internet to the at least one destination.

13. A picture kiosk apparatus according to claim 12, wherein the computer network is the internet.

14. A picture kiosk apparatus according to claim 1, wherein the determining means determines the at least one destination by querying a database containing assigned destinations.

15. A picture kiosk apparatus according to claim 1, wherein the obtained information includes at least one of a format and a description of content data.

16. A picture kiosk apparatus according to claim 1, wherein the obtained information includes identification information of a user.

17. An apparatus for uploading information, said apparatus comprising:
means for receiving a number of types of portable memory devices;
means for obtaining stored identification data and content data from a received portable memory device;
means for determining at least one destination based on the obtained identification data; and
means for outputting a data signal representative of at least a portion of the obtained content data for supply to the at least one destination.

18. An apparatus according to claim 17, wherein the types of portable memory devices include at least one of a memory stick, a floppy disk, a scan medium, a hard disk, and a compact flash.

19. An apparatus according to claim 18, wherein the content data stored in the respective memory device includes video information corresponding to a number of pictures.

20. An apparatus according to claim 18, wherein the content data stored in the respective memory device includes video information corresponding to a number of moving image video clips.

21. An apparatus according to claim 17, further comprising means for determining the type of the received portable memory device.

22. An apparatus according to claim 21, wherein the type of the received portable memory device is determined based on the obtained identification data.

23. An apparatus according to claim 17, wherein the obtained identification data includes destination information, and wherein the determining means determines the at least one destination based on the destination information.

24. An apparatus according to claim 23, wherein the destination information includes at least one of an email address and a URL path.

25. An apparatus according to claim 17, wherein the at least one destination includes at least one of an email address and a URL path.

26. An apparatus according to claim 17, further comprising means for erasing at least the portion of the obtained content data from the received portable memory device.

27. An apparatus according to claim 17, further comprising:
means for presenting the obtained content data; and
means for receiving a selection on the presented content data, wherein
the at least a portion of the obtained content data includes the selected content data.

28. An apparatus according to claim 17, wherein the outputting means is adapted to be coupled to a computer network for outputting the data signal representative of the at least a portion of the content data for supply by way of the internet to the at least one destination.

29. An apparatus according to claim 28, wherein the computer network is the internet.

30. An apparatus according to claim 17, wherein the determining means determines the at least one destination by querying a database containing destinations assigned to respective identification information.

31. An apparatus according to claim 17, wherein the qobtained identification data

32. An apparatus according to claim 17, wherein the obtained identification data

33. A method of receiving and outputting information at a picture kiosk apparatus, said method comprising the steps of:
receiving a portable memory device, said received portable memory device being one of a number of types of portable memory devices usable with and detachable from at least one of a video camera and a still-picture camera;
obtaining stored information from a received portable memory device;
determining at least one destination; and
outputting a data signal representative of at least a portion of the obtained information.

34. A method according to claim 33, wherein the types of portable memory devices include at least one of a memory stick, a floppy disk, a scan medium, a hard disk, and a compact flash.

35. A method according to claim 34, wherein the information stored in the respective memory device includes video information corresponding to a number of pictures.

36. A method according to claim 34, wherein the information stored in the respective memory device includes video information corresponding to a number of moving image video clips.

37. A method according to claim 34, wherein the information stored in the respective memory device includes identification information.

38. A method according to claim 33, further comprising the step of determining the type of the received portable memory device.

39. A method according to claim 33, wherein
the obtained information includes destination information, and
the at least one destination is determined based on the destination information.

40. A method according to claim 33, further comprising the step of receiving a destination designation, and wherein the at least one destination is determined based on the received destination designation.

41. A method according to claim 33, wherein the at least one destination includes at least one of an email address and a URL path.

42. A method according to claim 33, further comprising the step of erasing at least the portion of the obtained information from the received portable memory device.

43. A method according to claim 33, further comprising the steps of:
presenting the obtained information; and
receiving a selection on the presented information, wherein
the at least a portion of the obtained information includes the selected information.

44. A method according to claim 33, wherein the data signal is outputted to a computer network for supplying to the at least one destination by way of the internet.

45. A method according to claim 44, wherein the computer network is the internet.

46. A method according to claim 33, wherein the at least one destination is determined at the determining step by querying a database containing assigned destinations.

47. A method according to claim 33, wherein the obtained information includes at least one of a format and a description of content data.

48. A method according to claim 33, wherein the obtained information includes identification information of a user.

49. A method of uploading information, said method comprising the steps of:
receiving a portable memory device, said received portable memory device being one of a number of types of portable memory devices;
obtaining stored identification data and content data from a received portable memory device;
determining at least one destination based on the obtained identification data; and
outputting a data signal representative of at least a portion of the obtained content data for supply to the at least one destination.

50. A method according to claim 49, wherein the types of portable memory devices include at least one of a memory stick, a floppy disk, a scan medium, a hard disk, and a compact flash.

51. A method according to claim 50, wherein the content data stored in the respective memory device includes video information corresponding to a number of pictures.

52. A method according to claim 50, wherein the content data stored in the respective memory device includes video information corresponding to a number of moving image video clips.

53. A method according to claim 49, further comprising the step of determining the type of the received portable memory device.

54. A method according to claim 53, wherein the type of the received portable memory device is determined based on the obtained identification data.

55. A method according to claim 49, wherein the obtained identification data includes destination information, and wherein the at least one destination is determined at the determining step based on the destination information.

56. A method according to claim 55, wherein the destination information includes at least one of an email address and a URL path.

57. A method according to claim 49, wherein the at least one destination includes at least one of an email address and a URL path.

58. A method according to claim 49, further comprising the step of erasing at least the portion of the obtained content data from the received portable memory device.

59. A method according to claim 49, further comprising the steps of:
presenting the obtained content data; and
receiving a selection on the presented content data, wherein
the at least a portion of the obtained content data includes the selected content data.

60. A method according to claim 49, wherein the data signal is outputted to a computer network for supplying to the at least one destination by way of the internet.

61. A method according to claim 60, wherein the computer network is the internet.

62. A method according to claim 49, wherein the at least one destination is determined at the determining step by querying a database containing destinations assigned to respective identification information.

63. A picture kiosk apparatus, comprising:
a number of interfaces adapted to receive a number of respective types of portable memory devices and to obtain stored information from a received portable memory device, said types of portable memory devices being usable with and detachable from at least one of a video camera and a still-picture camera;
a processor coupled to the number of interfaces, said processor adapted to determine at least one destination; and
a network adapter coupled to the processor, said network adapter adapted to output a data signal representative of at least a portion of the obtained information for supply to the at least one destination.

64. A picture kiosk apparatus, comprising:
a number of interfaces adapted to receive a number of respective types of portable memory devices and to obtain stored identification data and content data from a received portable memory device;
a processor coupled to the number of interfaces, said processor adapted to determine at least one destination based on the obtained identification data; and
a network adapter coupled to the processor, said network adapter adapted to output a data signal representative of at least a portion of the obtained content data for supply to the at least one destination.

65. A set of computer program instructions for receiving and outputting information, comprising:
an instruction for receiving data from a portable memory device, said portable memory device being one of a number of types of portable memory devices usable with and detachable from at least one of a video camera and a still-picture camera;
an instruction for obtaining stored information from said portable memory device;
an instruction for determining at least one destination; and
an instruction for outputting a data signal representative of at least a portion of the obtained information for supply to the at least one destination.

66. A set of computer program instructions for receiving and outputting information, comprising:
an instruction for receiving data from a portable memory device, said portable memory device being one of a number of types of portable memory devices;
an instruction for obtaining stored identification data and content data from said portable memory device;
an instruction for determining at least one destination based on the obtained identification data; and
an instruction for outputting a data signal representative of at least a portion of the obtained content data for supply to the at least one destination.

67. A portable memory device usable with and detachable from at least one of a video camera and a still-picture camera, said memory device comprising:
a data section for storing content data; and
a header section for storing identification information and at least one destination for sending said content data.

68. A kiosk apparatus for uploading information, said apparatus comprising:
means for receiving identification data and content data stored in a memory of a data device by way of wireless communication;
means for determining at least one destination based on the received identification data; and
means for outputting a data signal representative of at least a portion of the obtained content data for supply to the at least one destination.

69. A method of uploading information, said method comprising the steps of:
receiving identification data and content data stored in a memory of a data device by way of wireless communication;
determining at least one destination based on the received identification data; and
outputting a data signal representative of at least a portion of the obtained content data for supply to the at least one destination.

70. A picture kiosk apparatus, comprising:
a number of interfaces adapted to communicate with a number of types of portable devices by way of wireless communication and to receive stored identification data and content data from a portable device;
a processor coupled to the number of interfaces, said processor adapted to determine at least one destination based on the received identification data; and
a network adapter coupled to the processor, said network adapter adapted to output a data signal representative of at least a portion of the obtained content data for supply to the at least one destination.

71. A set of computer program instructions for receiving and outputting information, comprising:
an instruction for receiving identification data and content data stored in a portable device by way of wireless communication;
an instruction for determining at least one destination based on the received identification data; and
an instruction for outputting a data signal representative of at least a portion of the obtained content data for supply to the at least one destination.

72. The kiosk apparatus of claim 68, wherein said receiving means includes means for receiving said identification data and said content data by way of wired communication.

73. The picture kiosk apparatus of claim 1, wherein said receiving means is adapted to receive a plurality of types of portable memory devices usable with and detachable from at least one of a video camera and a still-picture camera.

74. The picture kiosk apparatus of claim 1, wherein said obtaining means automatically obtains identification information indicating the at least one destination from the received portable memory device.

75. The picture kiosk apparatus of claim 1, wherein the at least one destination includes an external destination.

76. The picture kiosk apparatus of claim 1, wherein the determining means includes input means for receiving an input indicating the at least one destination.
